(19) United States
(12) Patent Application Publication
(10) Pub. No.: US 2006/0098031 A1
(43) Pub. Date: May 11, 2006

(54) System and method for effectively performing image rotation procedures in a compressed domain

(76) Inventors: Jimmy Kwok Lap Lai, Vancouver (CA); Ardeshir Saghafi, Surrey (CA)

Correspondence Address: EPSON RESEARCH AND DEVELOPMENT INC;INTELLECTUAL PROPERTY DEPT, 150 RIVER OAKS PARKWAY, SUITE 225, SAN JOSE, CA, 95134, US

(21) Appl. No.: 10/973,377

(22) Filed: Oct. 26, 2004

(51) Int. Cl. G09G 5/00

(52) U.S. Cl. 345/649

(57) ABSTRACT

A system and method for effectively performing image rotation procedures in a compressed domain includes a compression module that performs data compression upon input data blocks to create compressed data blocks that have irregular storage sizes when packed into a display buffer. A rotation module stores compression storage information corresponding to the compressed data blocks into a rotation memory. A decompression module may then access the compression storage information from the rotation memory to locate and read certain of the compressed data blocks in pre-defined image rotation sequences for providing to a display device.

### BACKGROUND SECTION

1. Field of Invention

This invention relates generally to electronic display controller systems, and relates more particularly to a system and method for effectively performing image rotation procedures in a compressed domain.

2. Description of the Background Art

Implementing efficient methods for displaying electronic image data is a significant consideration for designers and manufacturers of contemporary electronic devices. However, efficiently displaying image data with electronic devices may create substantial challenges for system designers. For example, enhanced demands for increased device functionality and performance may require more system operating power and require additional hardware resources. An increase in power or hardware requirements may also result in a corresponding detrimental economic impact due to increased production costs and operational inefficiencies.

Furthermore, enhanced device capability to perform various advanced display control operations may provide additional benefits to a system user, but may also place increased demands on the control and management of various device components. For example, an enhanced electronic device that efficiently manipulates, transfers, and displays digital image data may benefit from an efficient implementation because of the large amount and complexity of the digital data involved.

Due to growing demands on system resources and substantially increasing data magnitudes, it is apparent that developing new techniques for controlling the display of electronic image data is a matter of concern for related electronic technologies. Therefore, for all the foregoing reasons, developing efficient systems for displaying electronic image data remains a significant consideration for designers, manufacturers, and users of contemporary electronic devices.

### SUMMARY

In accordance with the present invention, a system and method are disclosed for effectively performing image rotation procedures in a compressed domain. In certain embodiments, an electronic device may be implemented to include a central-processing unit (CPU), a display, and a display controller. In one embodiment, when implementing compression storage information in a rotation memory, the display controller initially receives and buffers input data transmitted from a data source. Then, a compression module from the display controller starts a compression procedure to compress and store the input data as blocks of compressed data in a display buffer.

A rotation module of the display controller latches a start block address for a current row of the compressed blocks. Then, the rotation module begins packing bit-per-pixel (BPP) values corresponding to each of the blocks in the current row. The rotation module next determines whether the memory width of the rotation memory has been reached for the packed BPP values. When the memory width of the rotation memory has been reached, then the rotation module writes any unstored compression storage information, such as the start block address and the BPP values, into the rotation memory.

The rotation module next determines whether the end of a current frame of the compressed blocks of image data has been reached in the display buffer. If the end of a current frame has been reached, then the process may return and repeat with a new frame of input data. However, if the end of the current frame has not yet been reached, then the rotation module may determine whether the end of a current row of blocks has been reached in the display buffer. If the end of a current row of blocks has not been reached, then the process may return and continue to pack additional BPP values.

However, if the end of a current row of blocks has been reached, then the rotation module may latch the end block address for the current row of blocks. The rotation module may then advance to the next row of blocks in the display buffer, and may store compression storage information for the next row (new current row) of blocks in the display buffer.

In certain embodiments, to support various image rotation procedures, a decompression module from the display controller initially detects an image rotation mode for presenting image data upon the display of the electronic device. The particular image rotation mode corresponds to an appropriate rotation sequence for reading blocks from the display buffer to provide to the display. The decompression module reads an appropriate block address (start block address or end block address) from the compression storage information in the rotation memory. The appropriate start/end block address may be selected depending upon the particular rotation sequence and the memory location of the target blocks to be read from the display buffer for the rotation sequence. The start/end block address may then be utilized as an initial reference point for locating the target blocks in the display buffer.

The decompression module may also read corresponding BPP values for the blocks from the initial reference point (start/end block address) to the desired target block. Then, since the number of pixels per block is known, the decompression module may utilize the retrieved BPP values to readily calculate the total number of intervening bits in the blocks between the initial reference point and the target block. Depending upon the memory width, the decompression module may utilize the total number of intervening bits and the start/end block address to calculate the address of the target block.

The decompression module then reads and decompresses the current target block. The decompression module next calculates the address for the next target block in the rotation sequence. The rotation module may then determine whether the end of a current frame of compressed blocks of image data has been reached in the display buffer. If the end of a current frame has been reached, then the process may return and repeat with a new frame of input data.

However, if the end of the current frame has not yet been reached, then the rotation module may determine whether the end of a current row of blocks has been reached in the display buffer. If the end of a current row of blocks has been reached, then the process may return and read a new start/end address for the new row. However, if the end of a current row of blocks has not yet been reached, the process may return to read appropriate BPP values for locating and decompressing additional target blocks for presentation upon the display in the selected rotation mode. For at least the foregoing reasons, the present invention therefore provides an improved system and method for effectively performing image rotation procedures in a compressed domain.

### BRIEF DESCRIPTION OF THE DRAWINGS

FIG. 1 is a block diagram for one embodiment of an electronic device, in accordance with the present invention;

FIG. 2 is a block diagram for one embodiment of the display controller of FIG. 1, in accordance with the present invention;

FIG. 3 is a block diagram for one embodiment of the video memory of FIG. 2, in accordance with the present invention;

FIG. 4 is a block diagram for one embodiment of the controller registers of FIG. 2, in accordance with the present invention;

FIG. 5 is a block diagram for one embodiment of the display of FIG. 1, in accordance with the present invention;

FIGS. 6A and 6B are drawings illustrating an exemplary embodiment for implementing compression storage information, in accordance with the present invention.

FIG. 7 is a diagram for one embodiment of a rotation memory for storing compression storage information, in accordance with the present invention;

FIG. 8 is a flowchart of method steps for implementing compression storage information in a rotation memory, in accordance with one embodiment of the present invention; and

FIG. 9 is a flowchart of method steps for utilizing compression storage information during a rotation mode, in accordance with one embodiment of the present invention.

### DETAILED DESCRIPTION

The present invention relates to an improvement in display controller systems. The following description is presented to enable one of ordinary skill in the art to make and use the invention, and is provided in the context of a patent application and its requirements. Various modifications to the embodiments disclosed herein will be apparent to those skilled in the art, and the generic principles herein may be applied to other embodiments. Thus, the present invention is not intended to be limited to the embodiments shown, but is to be accorded the widest scope consistent with the principles and features described herein.

The present invention comprises a system and method for effectively performing image rotation procedures in a compressed domain, and includes a compression module that performs data compression upon input data blocks to create compressed data blocks that have irregular storage sizes when packed into a display buffer. A rotation module stores compression storage information corresponding to the compressed data blocks into a rotation memory. A decompression module may then access the compression storage information from the rotation memory to locate and read certain of the compressed data blocks in pre-defined image rotation sequences for providing to a display device.

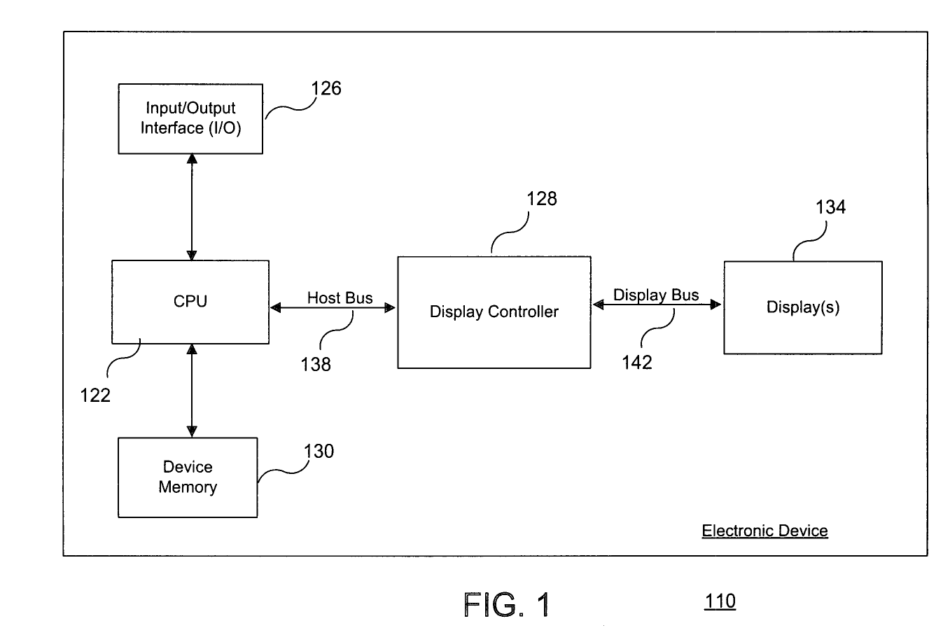

Referring now to FIG. 1, a block diagram for one embodiment of an electronic device 110 is shown, according to the present invention. The FIG. 1 embodiment includes, but is not limited to, a central processing unit (CPU) 122, an input/output interface (I/O) 126, a display controller 128, a device memory 130, and one or more display(s) 134. In alternate embodiments, electronic device 110 may include elements or functionalities in addition to, or instead of, certain of the elements or functionalities discussed in conjunction with the FIG. 1 embodiment.

In the FIG. 1 embodiment, CPU 122 may be implemented as any appropriate and effective processor device or microprocessor to thereby control and coordinate the operation of electronic device 110 in response to various software program instructions. In the FIG. 1 embodiment, device memory 130 may comprise any desired storage-device configurations, including, but not limited to, random access memory (RAM), read-only memory (ROM), and storage devices such as removable memory or hard disk drives. In the FIG. 1 embodiment, device memory 130 may include, but is not limited to, a device application of program instructions that are executed by CPU 122 to perform various functions and operations for electronic device 110. The particular nature and functionality of the device application typically varies depending upon factors such as the type and specific use of the corresponding electronic device 110.

In the FIG. 1 embodiment, the foregoing device application may include program instructions for allowing CPU 122 to provide image data and corresponding transfer and display information via host bus 138 to display controller 128. In accordance with the present invention, display controller 128 then responsively provides the received image data via display bus 142 to at least one of the display(s) 134 of electronic device 110. In the FIG. 1 embodiment, input/output interface (I/O) 126 may include one or more interfaces to receive and/or transmit any required types of information to or from electronic device 110. Input/output interface 126 may include one or more means for allowing a device user to communicate with electronic device 110. In addition, various external electronic devices may communicate with electronic device 110 through I/O 126. For example, a digital imaging device, such as a digital camera, may utilize input/output interface 126 to provide captured image data to electronic device 110.

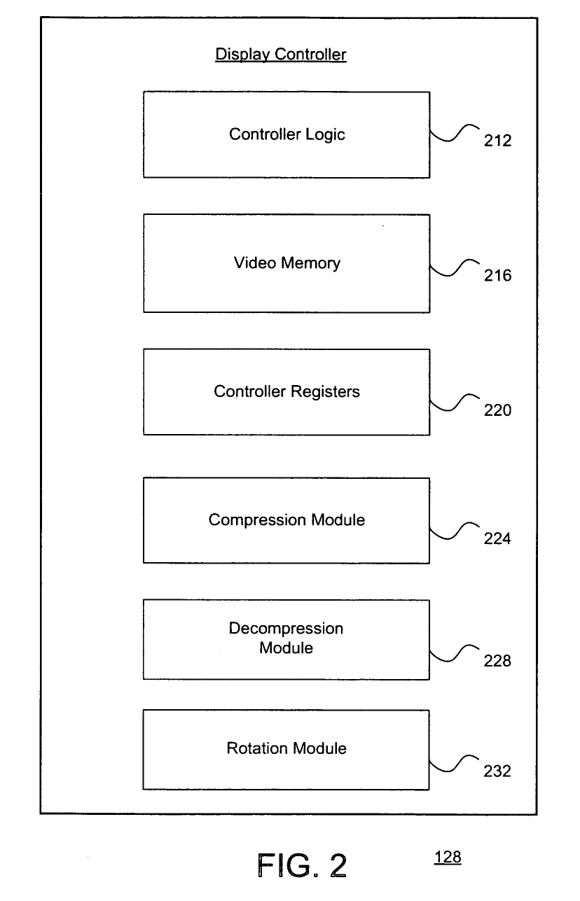

In the FIG. 1 embodiment, electronic device 110 may advantageously utilize display controller 128 for efficiently managing various operations and functionalities relating to display(s) 134. The implementation and functionality of display controller 128 is further discussed below in conjunction with FIGS. 2-4 and 6-9. In the FIG. 1 embodiment, electronic device 110 may be implemented as any desired type of electronic device or system. For example, in certain embodiments, electronic device 110 may alternately be implemented as a cellular telephone, a personal digital assistant device, an electronic imaging device, or a computer device. Various embodiments for the operation and utilization of electronic device 110 are further discussed below in conjunction with FIGS. 2-9.

Referring now to FIG. 2, a block diagram for one embodiment of the FIG. 1 display controller 128 is shown, in accordance with the present invention. The FIG. 2 embodiment includes, but is not limited to, controller logic 212, video memory 216, controller registers 220, a compression module 224, a decompression module 228, and a rotation module 232. In alternate embodiments, display controller 128 may include elements or functionalities in addition to, or instead of, certain of the elements or functionalities discussed in conjunction with the FIG. 2 embodiment.

In the FIG. 2 embodiment, display controller 128 may be implemented as an integrated circuit device that accepts image data and corresponding transfer and display information from CPU 122 (FIG. 1). Display controller 128 then automatically provides the received image data to display 134 of electronic device 110 in an appropriate and efficient manner for displaying to a device user. In the FIG. 2 embodiment, controller logic 212 manages and coordinates the overall operation of display controller 128.

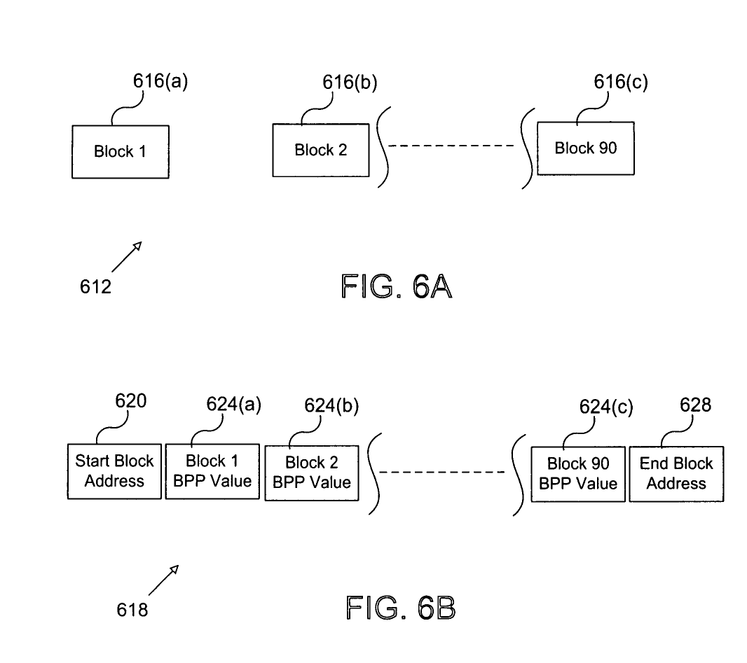

In the FIG. 2 embodiment, display controller 128 may utilize controller registers 220 to store various types of configuration, control and status information. In the FIG. 2 embodiment, display controller 128 may utilize compression module 224 to compress and write various types of information and input data into video memory 216 during corresponding compression operations. Similarly, display controller 128 may utilize decompression module 228 to read and decompress various types of information and output data from video memory 216 during corresponding decompression operations. In accordance with the present invention, display controller 128 may utilize rotation module 232 to store compression storage information into a rotation memory as further discussed below in conjunction with FIGS. 6A, 6B, 7, 8, and 9.

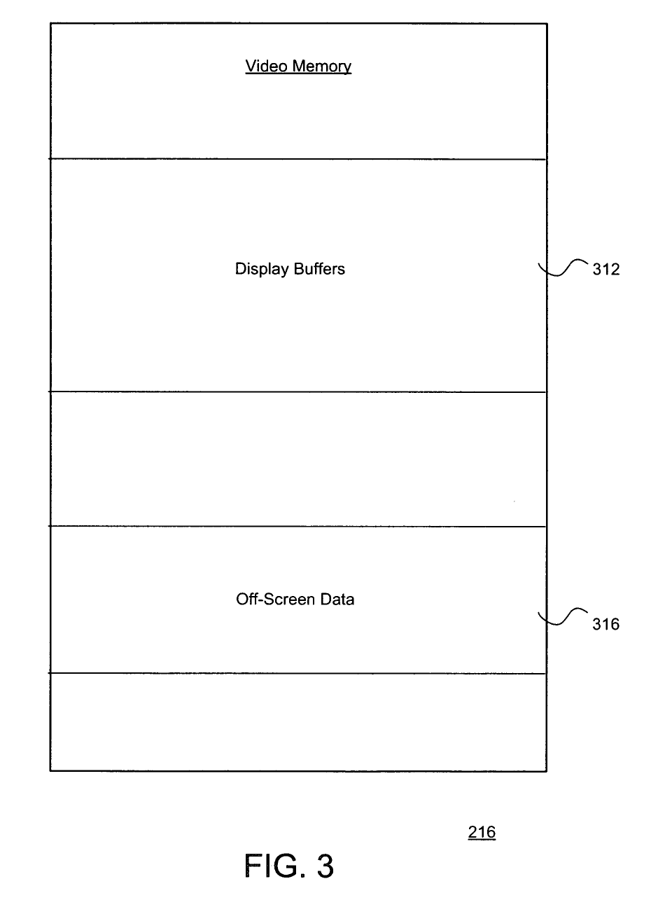

Referring now to FIG. 3, a block diagram for one embodiment of the FIG. 2 video memory 216 is shown, in accordance with the present invention. In the FIG. 3 embodiment, video memory 216 includes, but is not limited to, one or more display buffers 312 and off-screen data 316. In alternate embodiments, video memory 216 may include elements and functionalities in addition to, or instead of, certain of the elements and functionalities discussed in conjunction with the FIG. 3 embodiment.

In the FIG. 3 embodiment, video memory 216 may be implemented by utilizing any effective types of memory devices or configurations. For example, in certain embodiments, video memory 216 may be implemented as a random-access memory (RAM) device. In the FIG. 3 embodiment, compression module 224 or another appropriate source writes image data into display buffers 312 for subsequent transfer by display controller 128 to display 134 of electronic device 110 for viewing by a device user. In the FIG. 3 embodiment, display buffers 312 may be implemented with a double buffer scheme in which two buffers alternate store a series of consecutive frames of compressed image data.

In the FIG. 3 embodiment, off-screen data 316 may include any appropriate type of information or data that is not intended for presentation upon display 134 of electronic device 110. For example, off-screen data 316 may be utilized to cache certain fonts or other objects for use by display controller 128. In accordance with the present invention, off-screen data 316 may also include a rotation memory that is further discussed below in conjunction with FIGS. 6A, 6B, 7, 8, and 9.

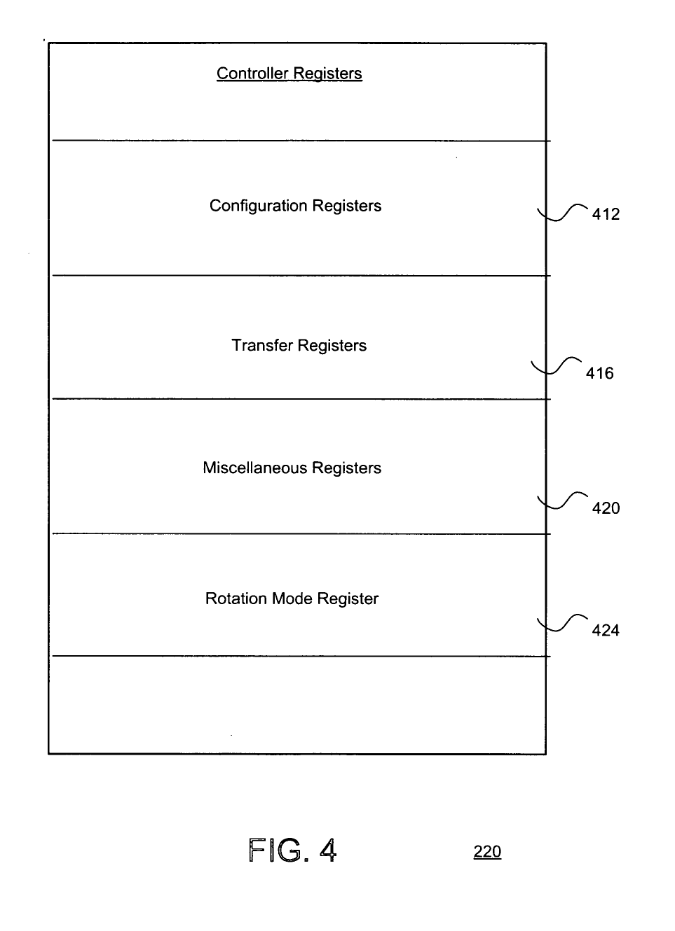

Referring now to FIG. 4, a block diagram for one embodiment of the FIG. 2 controller registers 220 is shown, in accordance with the present invention. In the FIG. 4 embodiment, controller registers 220 include, but are not limited to, configuration registers 412, transfer registers 416, miscellaneous registers 420, and a rotation mode register 424. In alternate embodiments, controller registers 220 may include elements and functionalities in addition to, or instead of, certain of the elements and functionalities discussed in conjunction with the FIG. 4 embodiment.

In the FIG. 4 embodiment, CPU 122 (FIG. 1) or other appropriate entities may advantageously write information into controller registers 220 to specify various types of operational parameters and other relevant information for use by configuration logic 212 of display controller 128. In the FIG. 4 embodiment, controller registers 220 may utilize configuration registers 412 for storing various types of information relating to the configuration of display controller 128 and/or display 134 of electronic device 110. For example, configuration registers 220 may specify a display type, a display size, a display frame rate, and various display timing parameters. In the FIG. 4 embodiment, controller registers 220 may utilize transfer registers 416 for storing various types of information relating to transfer operations for providing pixel data from video memory 216 (FIG. 3) to display 134 of electronic device 110.

In the FIG. 4 embodiment, controller registers 220 may utilize miscellaneous registers 420 for effectively storing any desired type of information or data for use by display controller 128. In the FIG. 4 embodiment, CPU 122 or other appropriate entity may program rotation mode register 424 to indicate to display controller 128 a particular degree of rotation desired for displaying image data on display 134.

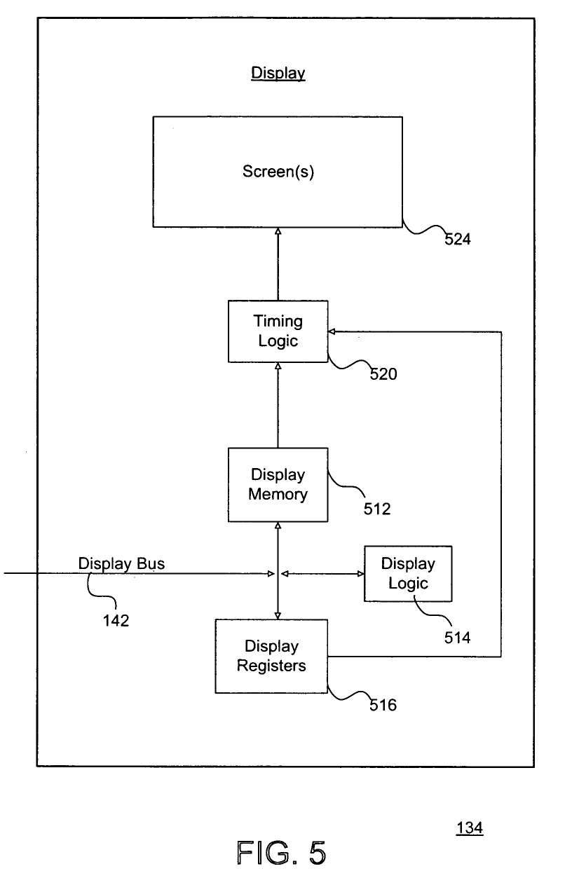

Referring now to FIG. 5, a block diagram for one embodiment of the FIG. 1 display 134 is shown, in accordance with the present invention. In the FIG. 5 embodiment, display 134 includes, but is not limited to, a display memory 512, display logic 514, display registers 516, timing logic 520, and one or more screen(s) 524. In alternate embodiments, display 134 may include elements and functionalities in addition to, or instead of, certain of the elements and functionalities discussed in conjunction with the FIG. 5 embodiment.

In the FIG. 5 embodiment, display 134 is implemented as a random-access-memory based liquid-crystal display panel (RAM-based LCD panel). However, in alternate embodiments, display 134 may be implemented by utilizing any type of appropriate display technologies or configurations. In the FIG. 5 embodiment, display controller 128 provides various types of display information to display registers 516 via display bus 142. Display registers 516 may then utilize the received display information for effectively controlling timing logic 520. In the FIG. 5 embodiment, display logic 514 manages and coordinates data transfer and display functions for display 134.

In the FIG. 5 embodiment, display controller 128 provides image data from display buffer 312 (FIG. 3) to display memory 512 via display bus 142. In the FIG. 5 embodiment, display memory 512 is typically implemented as random-access memory (RAM). However, in various other embodiments, any effective types or configurations of memory devices may be utilized to implement display memory 512. In the FIG. 5 embodiment, display memory 512 then advantageously provides the image data received from display controller 128 to one or more screens 524 via timing logic 520 for viewing by a device user of electronic device 110.

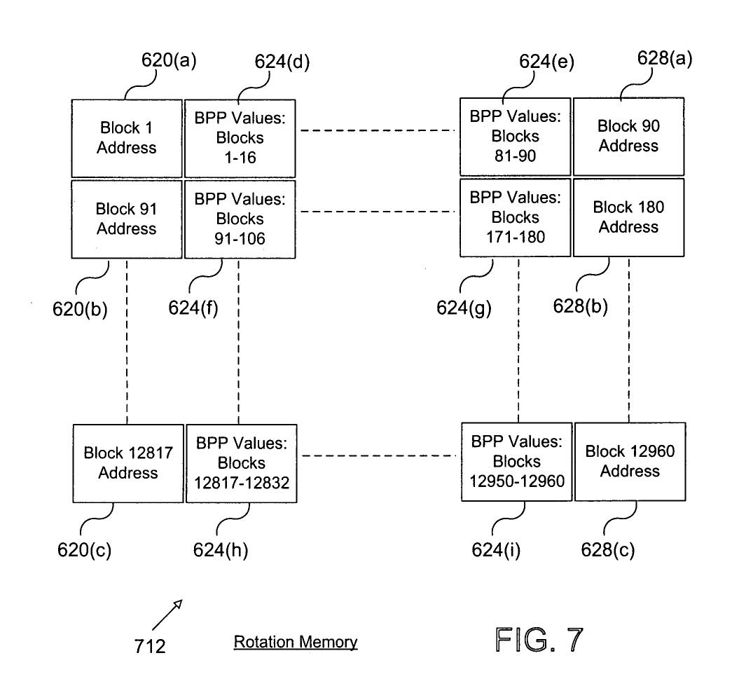

Referring now to FIGS. 6A and 6B, two drawings illustrating an exemplary embodiment for implementing compression storage information are shown. The example shown in FIGS. 6A and 6B is presented for purposes of illustration, and in alternate embodiments, the present invention may implement compression storage information by utilizing configurations and techniques in addition to, or instead of, certain of those configurations and techniques shown in the embodiment of FIGS. 6A and 6B. In the embodiments of FIGS. 6A, 6B, and 7, for purposes of illustration, the original uncompressed input data may be implemented in a YUV 4:2:0 format with an 8×4 block size of eight horizontal pixels and four vertical pixels, however any other appropriate format is equally contemplated.

The FIG. 6A drawing shows a row 612 of blocks 616 of image data that have been compressed from input data by compression module 224 (FIG. 2), and then stored into a display buffer 312 (FIG. 3). The FIG. 6A drawing shows a row 612 that consecutively comprises a block 1 (616(a)) through a block 90 (616(c)). In the FIG. 6A drawing, the intervening blocks between block 2 (616(b)) and block 90 (616(c)) are represented by a dashed line. During the compression procedures, compression module 224 encodes each of blocks 616 with a reduced number of compression bits, as compared to the larger number of uncompressed bits that are initially used to represent the input data.

The number of binary compression bits that are used to represent any given block of input data typically depends upon the particular content of that block. For example, a flat block with little or no variation between pixels may be represented by zero bits, a binary block with two main levels of pixels may be represented by one bit, and a standard block with three or more levels of pixels may be represented by three bits. The foregoing number of bits that are used by compression module 224 to represent the input blocks in a compressed domain are referred to herein as bit-per-pixel (BPP) values.

After performing the compression procedures, compression module 224 sequentially packs the compressed blocks 616 into a display buffer 312. However, because of the different number of bits used to represent individual blocks 616 in a compressed domain, the storage size of each block 616 is not constant. This irregular size of blocks 616 may cause significant difficulty in quickly determining the address of a given block 616 in display buffer 312 because the memory locations are not easily predictable.

In certain embodiments, CPU 122 (FIG. 1) or another appropriate entity may select a rotation mode to specify a rotation sequence with which decompression module 228 (FIG. 2) reads and decompressed specific blocks 616 from display buffer 312 for providing to display 134. Display 134 typically displays image data received from display controller 128 as if in a zero-degree rotation mode. Therefore decompression module 228 must alter the read sequence of blocks 616 from display buffers 312 so that display 134 presents the image data in the selected rotation mode. Accessing special sequences of blocks 616 to support various image rotation modes in display controller 128 may thus become problematical because of the variable storage size and unpredictable storage locations of blocks 616.

In accordance with the present invention, the FIG. 6B drawing shows compression storage information 618 stored by rotation module 232 into a rotation memory (see FIG. 7) for utilization by decompression module 228 in efficiently locating specific blocks 616 of compressed image data during various image rotation modes. For purposes of illustration, the compression storage information 618 shown in FIG. 6B corresponds to the row 612 of blocks 616 from the FIG. 6A embodiment.

In the FIG. 6B embodiment, rotation module 232 (FIG. 2) stores a start block address 620 to indicate the beginning address of the first block in a given row 612 from display buffer 312. In the FIG. 6B drawing, start block address 620 corresponds to block 1 (616(a)) from the row 612 of FIG. 6A. In the 6B embodiment, rotation module 232 then stores BBP values 624 for each block 616 in the current row 612 from display buffer 312. In the FIG. 6B drawing, the BPP values consecutively comprise a block 1 BPP value (624(a)) through a block 90 BPP value (624(c)). In the FIG. 6B drawing, the intervening BPP values 624 between block 2 BPP value (624(b)) and block 90 BPP value (624(c)) are represented by a dashed line.

In the FIG. 6B embodiment, block 1 BPP value 624(a) corresponds to block 1 (616(a)) from row 612 of the FIG. 6A drawing. Similarly, block 2 BPP value 624(b) corresponds to block 2 (616(b)) of FIG. 6A, and block 90 BPP value 624(c) corresponds to block 90 616(c) of FIG. 6A. In certain embodiments, rotation module 232 efficiently represents each BPP value 624 as a two-bit binary number. In the FIG. 6B embodiment, rotation module 232 (FIG. 2) may also store an end block address 628 to indicate the beginning address of the last block in a given row from display buffer 312. In the FIG. 6B drawing, end block address 628 corresponds to block 90 (616(c)) from the row 612 of FIG. 6A.

In accordance with the present invention, decompression module 228 or other appropriate entity may advantageously access compression storage information 618 to locate any desired block 616 in display buffers 312. For example, if decompression module 228 needs to access a given block 616 in a known row 612 of FIG. 6A, then decompression module 228 may utilize either start block address 620 or end block address 628 as an initial reference point for locating the desired target block 616. Choosing the initial reference point may depend upon which particular rotation mode is currently selected. Decompression module 228 may then total the intervening BPP values 624 between the reference point and the desired block 616 to accurately locate and read the desired target block 616 from display buffers 312. The creation and utilization of compression storage information 618 is further discussed below in conjunction with FIGS. 7-9.

Referring now to FIG. 7, a diagram for one embodiment of a rotation memory 712 for storing compression storage information 618 is shown. The FIG. 7 embodiment is presented for purposes of illustration, and in alternate embodiments, the present invention may utilize rotation memories that include configurations and elements in addition to, or instead of, certain of the configurations and elements discussed in conjunction with the FIG. 7 embodiment.

In the FIG. 7 embodiment, for purposes of illustration, rotation memory 712 is shown storing compression storage information 618 (FIG. 6) for image data in a known PAL format of 720×576 pixels. In the FIG. 7 embodiment, rotation memory 712 may be economically implemented with less than 16 Kbytes of memory space. In the FIG. 7 embodiment, rotation memory 712 therefore includes compression storage information 618 corresponding to 144 rows 612 (FIG. 6A) that each include 90 blocks 616 (FIG. 6A).

In the FIG. 7 embodiment, for purposes of illustration, compression storage information 618 for only the first two topmost rows and the bottom row in display buffer 312 are explicitly shown. The intervening compression storage information 618 for the remaining rows of blocks 616 in display buffer 312 are represented by dashed lines. More specifically, the top row of compression storage information 618 includes a start block 1 address 620(a), an end block 90 address 628(a), and a series of BBP values 624(d) through 624(e) for blocks 1 through 90 from display buffer 312.

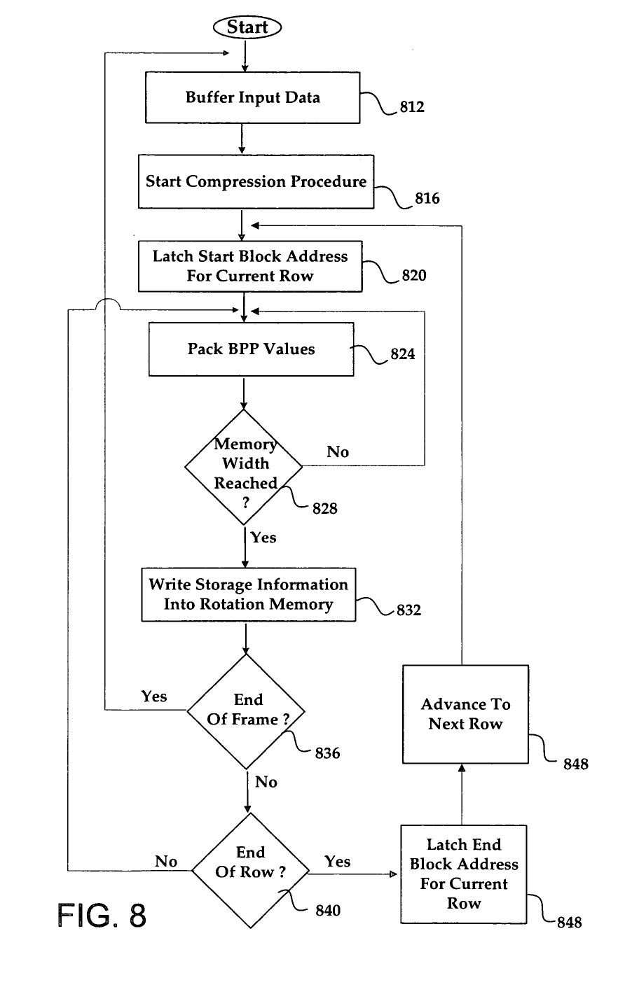

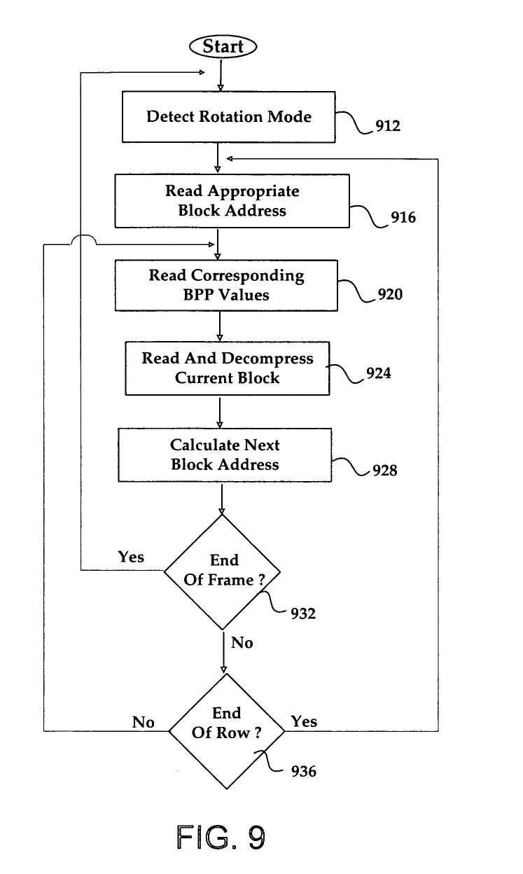

In the FIG. 7 embodiment, block addresses 620 and 628 are implemented as 32-bit addresses that are each stored in a single memory location. In addition, BPP values 624 are each implemented as 2-bit binary values that are stored in 5 units of 16 blocks each (for a total of 32 bits in each unit), with the exception of the final unit which stores 2-bit binary values for only 10 blocks (see for example, BPP values: blocks 81-90 (624(e)). In the FIG. 7 embodiment, the second row of compression storage information 618 includes a start block 91 address 620(b), an end block 180 address 628(b), and a series of BBP values 624(f) through 624(g) for blocks 91 through 180 from display buffer 312. Similarly, the bottom row of compression storage information 618 includes a start block 12817 address 620(c), an end block 12960 address 628(c), and a series of BBP values 624(h) through 624(i) for blocks 12817 through 12960 from display buffer 312. The creation and utilization of rotation memory 712 is further discussed below in conjunction with FIGS. 8-9.

Referring now to FIG. 8, a flowchart of method steps for implementing compression storage information 618 in a rotation memory 712 is shown, in accordance with one embodiment of the present invention. The FIG. 8 flowchart is presented for purposes of illustration, and in alternate embodiments, the present invention may utilize steps and sequences in addition to, or instead of, certain of the steps and sequences discussed in conjunction with the FIG. 8 embodiment.

In the FIG. 8 embodiment, in step 812, a display controller 128 initially receives and buffers input data transmitted from a data source. Then, in step 816, a compression module 224 starts a compression procedure to compress and store the input data as blocks 616 of compressed data in a display buffer 312. In step 820, a rotation module 232 latches a start block address 620 for a current row 612 of the blocks 616. Then, in step 824, rotation module 232 packs bit-per-pixel (BPP) values 624 corresponding to each of the blocks 616 in the current row 612.

In step 828, rotation module 232 determines whether the memory width of rotation memory 712 has been reached for the packed BPP values 624. In step 832, when the memory width of rotation memory 712 has been reached, then rotation module 232 writes any unstored compression storage information 618 into rotation memory 712. In step 836, rotation module 232 determines whether the end of a current frame of compressed blocks 616 of image data has been reached in display buffer 312. If the end of a current frame has been reached, then the FIG. 8 process may return and repeat from step 812 with a new frame of input data.

However, if the end of the current frame has not yet been reached, then in step 840, rotation module 232 may determine whether the end of a current row 612 of blocks 616 has been reached in display buffer 312. If the end of a current row 612 of blocks 616 has not been reached, then the FIG. 8 process may return and continue to pack BPP values 624 in foregoing step 824. However, if the end of a current row 612 of blocks 616 has been reached, then in step 844, rotation module 232 may latch the end block address 628 for the current row 612 of blocks 616.

In step 848, rotation module 232 may then advance to the next row 612 of blocks 616 in display buffer 312. The FIG. 8 process may then return to foregoing step 820, and may store compression storage information 618 for the next row 612 (new current row) of blocks 616 in display buffer 312. The FIG. 8 process therefore provides an improved system and method for implementing compression storage information 618 in rotation memory 712.

Referring now to FIG. 9, a flowchart of method steps for utilizing compression storage information 618 during a rotation mode is shown, in accordance with one embodiment of the present invention. The FIG. 9 flowchart is presented for purposes of illustration, and in alternate embodiments, the present invention may utilize steps and sequences in addition to, or instead of, certain of the steps and sequences discussed in conjunction with the FIG. 9 embodiment.

In the FIG. 9 embodiment, in step 912, a decompression module 228 detects an image rotation mode for presenting image data upon a display 134 of an electronic device 110. The particular image rotation mode corresponds to an appropriate rotation sequence for reading blocks 616 from a display buffer 312 to provide to display 134. Then, in step 916, decompression module 228 reads an appropriate block address (start block address 620 or end block address 628) from compression storage information 618 in a rotation memory 712. The appropriate start/end block address may be selected depending upon the particular rotation sequence and the memory location of the target blocks 616 to be read from display buffer 312 for the rotation sequence. The start/end block address 620/628 may then be utilized as an initial reference point for locating target blocks 616 in display buffer 312.

In step 920, decompression module 228 may read corresponding BPP values 624 for the blocks 616 from the initial reference point (start/end block address 620/628) to the target block 616. Then, since the number of pixels per block 616 is known, decompression module 228 may utilize the retrieved BPP values 624 to readily calculate the total number of intervening bits in the blocks 616 between the initial reference point and the target block 616. Depending upon the memory width, decompression module 228 may utilize the total number of intervening bits and the start/end block address 620/628 to calculate the address of the target block 616.

In step 924, decompression module 228 reads and decompresses the current target block 616. Then, in step 928, decompression module 228 calculates the address for the next target block 616 in the rotation sequence. In step 932, rotation module 232 determines whether the end of a current frame of compressed blocks 616 of image data has been reached in display buffer 312. If the end of a current frame has been reached, then the FIG. 9 process may return and repeat from step 912 with a new frame of input data.

However, if the end of the current frame has not yet been reached, then in step 936, rotation module 232 may determine whether the end of a current row 612 of blocks 616 has been reached in display buffer 312. If the end of a current row 612 of blocks 616 has been reached, then the FIG. 8 process may return and read a new start/end address for a new row 612 in foregoing step 916. However, if the end of a current row 612 of blocks 616 has not yet been reached, the FIG. 8 process may return to foregoing step 920 to read appropriate BPP values 624 for locating and decompressing additional target blocks 616 for presentation upon display 134 in the selected rotation mode. For at least the foregoing reasons, the present invention therefore provides an improved system and method for effectively performing image rotation procedures in a compressed domain.

The invention has been explained above with reference to certain preferred embodiments. Other embodiments will be apparent to those skilled in the art in light of this disclosure. For example, the present invention may be implemented using certain configurations and techniques other than those described in the embodiments above. Additionally, the present invention may effectively be used in conjunction with systems other than those described above as the preferred embodiments. Therefore, these and other variations upon the foregoing embodiments are intended to be covered by the present invention, which is limited only by the appended claims.

What is claimed is:

1. A system for facilitating image rotation modes in an electronic device, comprising:
a rotation module that stores compression storage information into a rotation memory, said compression storage information corresponding to compressed data blocks in a display buffer, said compression storage information including reference block addresses for reference blocks from said compressed data blocks, said compression storage information also including bit-per-pixel values for said compressed data blocks; and
a decompression module that accesses said compression storage information to locate and read certain of said compressed data blocks from pre-defined image rotation sequences.

2. The system of claim 1 wherein a compression module performs a data compression procedure upon input data blocks to create said compressed data blocks, said compression module selecting said bit-per-pixel values for representing said input data blocks in a compressed domain, said bit-per-pixel values depending upon specific image content in said input data blocks, said compressed blocks having irregular storage sizes when packed into said display buffer.

3. The system of claim 2 wherein said compression module, said decompression module, and said rotation module are implemented in a display controller that coordinates providing image data to a display device, said display controller being implemented as an integrated circuit device that functions as an interface between a central processing unit and said display device.

4. The system of claim 1 wherein said reference block addresses include start block addresses for rows of said compressed data blocks in said display buffer, said reference block addresses also including end block addresses for said rows of said compressed data blocks in said display buffer.

5. The system of claim 1 wherein each of said bit-per-pixel values indicates how many binary bits have been utilized by a compression module to represent pixels in a corresponding one of said compressed data blocks.

6. The system of claim 1 wherein said decompression module performs a decompression procedure upon said pre-defined rotation sequences, said pre-defined rotation sequences being provided to a data destination that includes a display for a portable electronic device.

7. The system of claim 5 wherein said portable electronic device is implemented as a portable cellular telephone device.

8. The system of claim 1 wherein said decompression module accesses said compression storage information to locate a target block in a known row of said display buffers, said decompression module utilizing said reference block address as an initial reference point for locating said target block.

9. The system of claim 8 wherein said decompression module totals all intervening ones of said bit-per-pixel values between said initial reference point and said target block to locate and read said target block from said display buffer.

10. The system of claim 8 wherein said decompression module utilizes a start block address as said initial reference point because of a currently selected image rotation mode.

11. The system of claim 8 wherein said decompression module utilizes an end block address as said initial reference point because of a currently selected image rotation mode.

12. The system of claim 1 wherein said display buffer and said rotation memory are implemented in corresponding double buffer configurations that sequentially store information for alternate image frames.

13. The system of claim 1 wherein said decompression module determines said pre-defined image rotation sequences by reading a programmable rotation mode register.

14. The system of claim 1 wherein said compressed data blocks represent compressed image data in a YUV 4:2:0 format.

15. The system of claim 1 wherein said compressed data blocks in said display buffer are compressed from input image data in a PAL format, said compressed data blocks being configured in 144 horizontal rows with ninety of said compressed data blocks in each of said horizontal rows.

16. The system of claim 1 wherein said rotation memory is implemented to store said compression storage information in a memory storage space of less than 16 Kbytes.

17. The system of claim 1 wherein said rotation memory is implemented as part of off-screen data in a display controller device.

18. The system of claim 1 wherein each of said bit-per-pixel values from said compression storage information is implemented as a two-bit binary value.

19. The system of claim 18 wherein said rotation memory is implemented with memory locations that are 32-bits wide, said reference block addresses each being 32 bits wide, each of said memory locations also being able to store sixteen of said bit-per-pixel values.

20. The system of claim 1 wherein said compression storage information in said rotation memory serves as a memory map of said compressed data blocks in said display buffer, said compressed data blocks being of irregular size, said compressed data blocks being stored into said display in an unpredictable manner, said decompression module utilizing said compression storage information to locate and read said compressed data blocks from said pre-defined image rotation sequence for supporting said image rotation modes.

21. A method for facilitating image rotation modes in an electronic device, comprising the steps of:
storing compression storage information into a rotation memory by utilizing a rotation module, said compression storage information corresponding to compressed data blocks in a display buffer, said compression storage information including reference block addresses for reference blocks from said compressed data blocks, said compression storage information also including bit-per-pixel values for said compressed data blocks; and
accessing said compression storage information with a decompression module to locate and read certain of said compressed data blocks from pre-defined image rotation sequences.

22. The method of claim 21 wherein a compression module performs a data compression procedure upon input data blocks to create said compressed data blocks, said compression module selecting said bit-per-pixel values for representing said input data blocks in a compressed domain, said bit-per-pixel values depending upon specific image content in said input data blocks, said compressed blocks having irregular storage sizes when packed into said display buffer.

23. The method of claim 22 wherein said compression module, said decompression module, and said rotation module are implemented in a display controller that coordinates providing image data to a display device, said display controller being implemented as an integrated circuit device that functions as an interface between a central processing unit and said display device.

24. The method of claim 21 wherein said reference block addresses include start block addresses for rows of said compressed data blocks in said display buffer, said reference block addresses also including end block addresses for said rows of said compressed data blocks in said display buffer.

25. The method of claim 21 wherein each of said bit-per-pixel values indicates how many binary bits have been utilized by a compression module to represent pixels in a corresponding one of said compressed data blocks.

26. The method of claim 21 wherein said decompression module performs a decompression procedure upon said pre-defined rotation sequences, said pre-defined rotation sequences being provided to a data destination that includes a display for a portable electronic device.

27. The method of claim 25 wherein said portable electronic device is implemented as a portable cellular telephone device.

28. The method of claim 21 wherein said decompression module accesses said compression storage information to locate a target block in a known row of said display buffers, said decompression module utilizing said reference block address as an initial reference point for locating said target block.

29. The method of claim 28 wherein said decompression module totals all intervening ones of said bit-per-pixel values between said initial reference point and said target block to locate and read said target block from said display buffer.

30. The method of claim 28 wherein said decompression module utilizes a start block address as said initial reference point because of a currently selected image rotation mode.

31. The method of claim 28 wherein said decompression module utilizes an end block address as said initial reference point because of a currently selected image rotation mode.

32. The method of claim 21 wherein said display buffer and said rotation memory are implemented in corresponding double buffer configurations that sequentially store information for alternate image frames.

33. The method of claim 21 wherein said decompression module determines said pre-defined image rotation sequences by reading a programmable rotation mode register.

34. The method of claim 21 wherein said compressed data blocks represent compressed image data in a YUV 4:2:0 format.

35. The method of claim 21 wherein said compressed data blocks in said display buffer are compressed from input image data in a PAL format, said compressed data blocks being configured in 144 horizontal rows with ninety of said compressed data blocks in each of said horizontal rows.

36. The method of claim 21 wherein said rotation memory is implemented to store said compression storage information in a memory storage space of less than 16 Kbytes.

37. The method of claim 21 wherein said rotation memory is implemented as part of off-screen data in a display controller device.

38. The method of claim 21 wherein each of said bit-per-pixel values from said compression storage information is implemented as a two-bit binary value.

39. The method of claim 38 wherein said rotation memory is implemented with memory locations that are 32-bits wide, said reference block addresses each being 32 bits wide, each of said memory locations also being able to store sixteen of said bit-per-pixel values.

40. The method of claim 21 wherein said compression storage information in said rotation memory serves as a memory map of said compressed data blocks in said display buffer, said compressed data blocks being of irregular size, said compressed data blocks being stored into said display in an unpredictable manner, said decompression module utilizing said compression storage information to locate and read said compressed data blocks from said pre-defined image rotation sequence for supporting said image rotation modes.

41. A system for facilitating image rotation modes in an electronic device, comprising:
means for storing compression storage information into a rotation memory, said compression storage information corresponding to compressed data blocks in a display buffer, said compression storage information including reference block addresses for reference blocks from said compressed data blocks, said compression storage information also including bit-per-pixel values for said compressed data blocks; and
means for accessing said compression storage information to locate and read certain of said compressed data blocks from pre-defined image rotation sequences.

42. A system for facilitating image rotation modes in an electronic device, comprising:
a rotation module that stores compression storage information into a rotation memory, said compression storage information corresponding to compressed data blocks in a display buffer; and
a decompression module that accesses said compression storage information to locate and read certain of said compressed data blocks from pre-defined image rotation sequences.
